(19) United States
(12) Patent Application Publication
(10) Pub. No.: US 2011/0318499 A1
(43) Pub. Date: Dec. 29, 2011

(54) Laser fusible coating compositions used for laser making systems and methods

(76) Inventor: Jagdip Thaker, Schaumburg, IL (US)

(21) Appl. No.: 13/135,039

(22) Filed: Jun. 23, 2011

Related U.S. Application Data
(60) Provisional application No. 61/398,296, filed on Jun. 24, 2010.

(51) Int. Cl. C08J 7/04; C09J 131/04; C09J 127/12

(52) U.S. Cl. 427/466; 427/511; 524/545; 524/531

(57) ABSTRACT

A laser fusible composition comprises a marking component, e.g. plastic dyes and pigments, coated with hot melt adhesive composition which can absorb laser irradiation at 780-10600 nm, and thereby causes through laser fusing, the composition to adhere firmly to metals, ceramics, glass, porcelain, marble, natural stone, paper and cardboards when heated.

### CROSS REFERENCE TO RELATED APPLICATIONS

This application claims the benefit of U.S. Provisional Application Ser. No. 61/398,296, filed Jun. 24, 2010, herein incorporated by reference.

### FIELD OF INVENTION

This invention relates to laser fusible coating compositions and, in particular, laser-fusible laser marking compositions that can be semi-permanently or permanently affixed to a substrate via laser irradiation.

### BACKGROUND OF THE INVENTION

WO02/01250 discloses the use of oxymetal salts in laser marking. AOM (ammonium octamolybdate) is an example of a material that can be marked directly with 10,600 nm laser radiation. However, the use of a NIR (near infra-red) laser would offer additional advantages.

WO05/068207 discloses the use of NIR laser radiation (i.e. at 800 to 2000 nm) to initiate a color change reaction when a MR-absorbing metal salt is used in combination with a substance that normally undergoes a color change reaction at much longer wavelength (about 10,600 nm), e.g. AOM. A plethora of metal salts are described; particularly preferred/ salts are of copper, e.g. CHP (copper hydroxy phosphate).

WO05/095516 discloses that r-ITO (reduced indium tin oxide), a non-stoichiometric compound, can be incorporated into thermoplastics which are then heated, using non-laser NIR heating lamps, above their glass transition temperatures for stretch blow-molding, e.g. in the production of PET beverage bottles from injection-molded performs. r-ITO is particularly suitable for this purpose as it is mostly transparent in the visible region:

JP8127670 discloses the use of reduced titanium oxide compounds for incorporation into thermoplastics, for the laser marking of molded products.

U.S. Pat. No. 5,578,120 describes the use of a laser beam-absorbing inorganic substance and a colorant. Examples of the colorants that can be used include those mentioned in JP-A-49-82340, e.g. zinc oxide semiconductors and titanium dioxide semiconductors.

U.S. Pat. No. 5,911,921 discloses the use of non-stoichiometric ytterbium phosphate to produce NIR absorbing inks, e.g. for printing stealth bar codes.

U.S. Pat. No. 6,602,595 discloses the use of non-stoichiometric nano-materials for use in inks. r-ITO is mentioned as an NIR absorber.

Non-reactive melt adhesives are known. EP 1124911 (U.S. Pat. No. 6,872,279), for example, describes melt adhesives manufactured on the basis of poly-.alpha.-olefins. These are described in particular for application of the melt adhesive by spraying. EP 388712 describes melt adhesives based on ethylene-acrylic acid-acrylic ester copolymers. These copolymers serve for the bonding of solid substrates. Furthermore, EP 890584 (U.S. Pat. No. 6,143,846) describes melt adhesives that are based on polyolefins manufactured by metallocene-catalyzed synthesis. Melt adhesives of this kind are notable for a particularly narrow molecular weight distribution and a narrow melting range.

EP 498998 describes a process for heating polymer material wherein the polymer material contains dispersed ferromagnetic particles. These mixtures can be heated by microwave irradiation so that the melting temperature of the polymer material is exceeded. EP 629490 describes polymers that are meltable or crosslinkable at high temperature, which contain finely divided powders made of substances that form dipoles and are sensitive to microwave radiation. The compositions are not further specified.

### SUMMARY OF INVENTION

Described herein are compositions, systems and method related to laser fusible coating compositions which can be used for laser marking. The present invention combines a colorant, color marking component, marking pigment and/or dyes (collectively referred to as a “marking component”) with a hot melt adhesive or polymer alloy (collectively referred to as “hot melt adhesive”), which in combination (the combination, referred to herein sometimes as “laser marking composition”) provides a color, black and/or white laser mark (when heated) with improved durability as compared with the current art. In some embodiments, the black and/or white and/or color laser mark is a high-contrast laser mark.

The combination of the suitable pigments and/or dyes as described herein with a hot melt adhesive increases the durability of the mark, rendering it permanent or semi-permanent on a substrate or device to which it is applied. The present invention can utilize a laser, for example a low to high powered laser, to economically laser-mark substrates with the laser marking composition of the present invention.

This invention is based on the discovery that many pigments and dyes absorb a majority of laser wavelengths, and in particular IR or Near-IR laser wavelengths. When a formulation containing the pigment and/or dyes along with one or more hot melt adhesives is heated (using any variety of methods and in particular laser light), which heat up and melt the hot melt adhesive, causing a mixture of the foregoing to stick (permanently or semi-permanently) to any material on which it is applied to form an image or pattern. Such an image or pattern can be formed by the localized application or irradiation with a laser in the desired pattern after uniform coating of a substrate. In some embodiments, the present invention utilizes a low-energy laser, such as a diode laser, typically emitting light at a wavelength in the range of 800 nm to 11000 nm.

According to the present invention, the potential of utilizing fibre, diode, diode array and CO₂ lasers for imaging applications on a substrate, for example, of plastic or cardboard packaging can be realized. It has been shown that, by the application of liquid film-forming formulations (such as inks) onto various substrates to produce coatings capable of distinct colors, exposure to near-IR sources produces good results dependent primarily on the formulation of the coated pigment powders.

The present invention will become apparent from the following detailed description and examples, which comprises, in one aspect is laser marking composition comprising (i) a marking component and (ii) a hot melt adhesive, the hot melt adhesive comprising a polymer having at least one monomeric unit having a fluoride group, and at least one monomeric unit having a glycidyl group. Upon irradiation at a wavelength range of between about 700 nm and 14000 nm, the laser marking composition bonds to a substrate to which it is contacted. In one embodiment, the composition further comprises a binder.

In another embodiment, the hot melt adhesive is a polymer comprising two or more monomeric units, wherein the two or more monomeric units are individually derived from: vinylidene fluoride, hexafluoropropylene, chlorotrifluoroethylene, tetrafluoroethylene, glycidyl acrylate, glycidyl methacrylate, an ethylenically unsaturated monomer, acrylic acid, polyvinyl acetate, acrylic acid esters, methacrylic acid, methacrylic acid esters, styrene, alpha-methyl styrene, vinyl chloride, acrylonitrile, methacrylonitrile, ureido methacrylate, vinyl acetate, vinyl esters of branched tertiary monocarboxylic acids, butyl acrylate, itaconic acid, crotonic acid, maleic acid, fumaric acid, ethylene, or C4-C8 conjugated dienes, 1,3-butadiene, isoprene and chloroprene, trimethylammoniopropyl methacrylate chloride, trimethylammonioethylacrylamide, -methacrylamide chloride, -methacrylamide bromide, trimethylammoniobutylacrylamide, -methylacrylamide methyl sulphate, trimethylammoniopropylmethacrylamide methyl sulphate, (3-methacrylamidopropyl)trimethylammonium chloride, (3-acrylamidopropyl)trimethylammonium chloride, methacryloyloxyethyltrimethylammonium chloride, methacryloyloxyethyltrimethylammonium chloride methyl sulphate, acryloyloxyethyltrimethylammonium salts, 1-ethyl-2-vinylpyridinium, 1-ethyl-4-vinylpyridinium bromide, 1-ethyl-2-vinylpyridinium, 1-ethyl-4-vinylpyridinium chloride, 1-ethyl-2-vinylpyridinium, 1-ethyl-4-vinylpyridinium methyl sulphate, N,N-dimethyldiallylammonium chloride, dimethylaminopropylmethacrylamide, or N-(3-chloro-2-hydroxypropyl)trimethylammonium chloride.

In yet another embodiment, the hot melt adhesive is a polymer comprising at least 3 monomeric units, wherein each monomeric unit is derived from a monomer selected from: vinylidene fluoride, hexafluoropropylene, chlorotrifluoroethylene, tetrafluoroethylene, glycidyl acrylate, glycidyl methacrylate, polyvinyl acetate, vinyl acetate or butyl acrylate.

The marking component can be any one or a combination of monoazo pigments, C.I. Pigment Brown, C.I. Pigment Orange, C.I. Pigment Red, C.I. Pigment yellow; diazo pigments, C.I. Pigment Orange, anthanthrone pigments, anthraquinone pigments, C.I. Pigment Violet, anthrapyrimidine pigments, quinophthalone pigments, dioxazine pigments, flavanthrone pigments, C.I. Pigment Blue, isoindoline pigments, isoviolanthrone pigments, metal-complex pigments, C.I. Pigment Green; perinone pigments, perylene pigments, C.I. Pigment Black, phthalocyanine pigments, pyranthrone pigments, thioindigo pigments, triarylcarbonium pigments, Aniline Black, Aldazine Yellow, C.I. Pigment Brown or liquid crystal polymer pigments (LCP pigments).

In one embodiment, the substrate comprises metal, ceramic, glass, porcelain, marble, natural stone, plastic, paper, rubber, wood, cardboard or a combination thereof. In another embodiment, the substrate is selected from the group consisting of glass, lead-free glass, ceramic tiles, sanitary ware, stoneware, porcelain, bricks, electronic quality ceramic substrates, marble, granite, slate, limestone, metal, steel, brass, copper, aluminum, tin, zinc, PVC, polyamides, polyolefins, polyethylenes, polycarbonates and polytetrafluoroethylene.

In another aspect, described herein are methods of laser marking a substrate in a desired pattern comprising: a) obtaining a laser marking composition comprising a marking composition and a hot melt adhesive; b) contacting the composition with a substrate; and c) irradiating the composition with a laser having a wavelength of between about 700 nm and 11000 nm, thereby causing the composition to form a bond with the substrate.

In one embodiment, the method incorporates use of a hot melt adhesive comprises a polymer having at least one monomeric unit having a fluoride group, and at least one monomeric unit having a glycidyl group.

In another embodiment, the hot melt adhesive comprises a polymer which, based on the total weight of monomers, comprises the following: (a) from about 65 to about 80 percent by weight fluoride monomeric units, each fluoride monomeric unit independently comprising at least one fluoride substituent group, (b) from about 20 to about 35 percent by weight glycidyl monomeric units, each glycidyl monomeric unit independently comprising at least one glycidyl group, and (c) from about 0.5 to about 2.0 percent by weight nonionic monomeric units, each nonionic monomeric unit independently comprising a nonionic substituent group.

In one embodiment, the hot melt adhesive is a polymer comprising two or more monomeric units, wherein the two or more monomeric units are individually derived from: vinylidene fluoride, hexafluoropropylene, chlorotrifluoroethylene, tetrafluoroethylene, glycidyl acrylate, glycidyl methacrylate, an ethylenically unsaturated monomer, acrylic acid, polyvinyl acetate, acrylic acid esters, methacrylic acid, methacrylic acid esters, styrene, alpha-methyl styrene, vinyl chloride, acrylonitrile, methacrylonitrile, ureido methacrylate, vinyl acetate, vinyl esters of branched tertiary monocarboxylic acids, butyl acrylate, itaconic acid, crotonic acid, maleic acid, fumaric acid, ethylene, or C4-C8 conjugated dienes, 1,3-butadiene, isoprene and chloroprene, trimethylammoniopropyl methacrylate chloride, trimethylammonioethylacrylamide, -methacrylamide chloride, -methacrylamide bromide, trimethylammoniobutylacrylamide, -methylacrylamide methyl sulphate, trimethylammoniopropylmethacrylamide methyl sulphate, (3-methacrylamidopropyl)trimethylammonium chloride, (3-acrylamidopropyl)trimethylammonium chloride, methacryloyloxyethyltrimethylammonium chloride, methacryloyloxyethyltrimethylammonium chloride methyl sulphate, acryloyloxyethyltrimethylammonium salts, 1-ethyl-2-vinylpyridinium, 1-ethyl-4-vinylpyridinium bromide, 1-ethyl-2-vinylpyridinium, 1-ethyl-4-vinylpyridinium chloride, 1-ethyl-2-vinylpyridinium, 1-ethyl-4-vinylpyridinium methyl sulphate, N,N-dimethyldiallylammonium chloride, dimethylaminopropylmethacrylamide, or N-(3-chloro-2-hydroxypropyl)trimethylammonium chloride.

In another embodiment, the hot melt adhesive is a polymer comprising at least 3 monomeric units, wherein each monomeric unit is derived from a monomer selected from: vinylidene fluoride, hexafluoropropylene, chlorotrifluoroethylene, tetrafluoroethylene, glycidyl acrylate, glycidyl methacrylate, polyvinyl acetate, vinyl acetate or butyl acrylate.

In yet another embodiment, the method can further comprising the step of determining a desired pattern to be formed on the substrate. Contacting the composition with a substrate can comprise electrostatially applying a layer of the composition onto the substrate or spraying a layer of the composition onto the substrate. In one embodiment, the pattern to be formed on the substrate can be of a bar code, an identifying code or a name, or any other identifying mark or artistic mark.

In another aspect, described herein is a method for forming an image on a substrate, the method comprising the steps of: applying onto the substrate a laser marking composition, and irradiating the substrate with a laser.

### DETAILED DESCRIPTION OF INVENTION

The IR absorber pigments and dyes, i.e., marking components, used in the present invention should be compatible with the desired color chemistry. In one embodiment, the marking components has no or minimal absorption in the visible region of the absorption spectrum, and is an efficient absorber of radiation at a wavelength of from about 700 nm to about 12000 nm. In another embodiment, the IR absorber pigments and dyes are an efficient absorber of radiation at a wavelength of from about 780 nm to about 10600 nm. In yet another embodiment, the IR absorber pigments and dyes used in this invention are an efficient absorber of radiation at a wavelength of from about 780 nm to about 10000 nm. The marking components, in yet a further embodiment, absorbs radiation in the near infrared region (NIR) of the electromagnetic spectrum (i.e. 780 to 3000 nm).

In one embodiment, the marking component is inorganic in nature. In another embodiment, the marking component is organic in nature. In one embodiment, the marking component has a thermally stability at above 150° C., more typically above 200° C., and possess good light stability and weatherability profiles. In one embodiment, the marking component is colorless or imparts minimal color in the finished coating formulation. The marking component, in one embodiment, is water-stable, has minimal solubility in water, and/or is compatible with water-based binders. In another embodiment, the marking component is compatible with common organic solvents. Such solvents include but are not limited to solvents that are environmentally friendly, readily available and non-toxic.

In accordance with the present invention, a hot melt adhesive is blended, for example, melt blended or mixed, with a marking component to form a formulation. The hot melt adhesive can be pre-processed by, for example, pulverizing, drying, crushing, grinding. The hot melt adhesive can also be pre-treated with an inclusion or addition of inert materials. Other pre-treatment steps can include steps that would be customary or apparent to one skilled in the art. It is understood however that any pre-treatment step is optional. In one embodiment, the hot melt adhesive and marking component is sufficiently mixed before melting so as to disperse the pigment or dye of the marking component evenly in the molten hot melt adhesive. This results in an even or generally uniform coating of all pigment particles with hot melt adhesive, so that when pulverized into a powder, the fine powder will melt evenly with laser energy.

The mixture of the hot melt adhesive and marking component of the present invention melts under the influence of the laser (or in other embodiments an alternate heat source), which binds and stabilizes the components of the mixture to themselves. The influence of the laser also binds the mixture to a workpiece, machine, material, device or substrate (It is understood that the term “substrate” also includes a workpiece, machine, material or device.) The substrate can be made from a conductive or dielectric material, or a combination of both. Examples of suitable substrates for use with the present invention include but are not limited to metal, glass, brick, stone, ceramic, porcelain, plastic, marble, granite, natural stone, rubber, paper, cardboard and corrugated cardboard, and the like.

Glass substrate compositions capable of being laser-marked by the present invention include lead as well as lead-free glasses such as soda lime silicates, borosilicates, aluminum silicates, fused silica and the like.

Ceramic substrates capable of being laser marked by the present invention include tiles, sanitary ware, stoneware bodies, porcelain bodies and bricks, as well as electronic quality ceramic substrates such as silica, alumina, aluminum nitride, etc.

Natural stone substrates can include but are not limited to marble, granite, slate, limestone and the like. Suitable metal substrates include but are not limited to steel, brass, gold, silver, platinum, copper, aluminum, tin, zinc, alloys thereof and the like.

Typical plastic substrates include but are not limited to PVC, polyamides, polyolefins, polyethylenes, polycarbonates and polytetrafluoroethylene.

Combinations of the above substrate materials may also be used, such as glass coated steel workpieces, glass coated ceramic substrates or workpieces as sell as any substrate coated with an epoxy or enamel.

Exemplary substrates that can be laser-marked in accordance with the present invention include but are not limited to electronic gaskets, rubber o-rings, devices, printed circuit boards, automotive parts, automotive glass, aerospace parts, medical devices, tooling, consumer products, packaging, glass bottles, metal cans, metal tags, rubber tires, rubber bricks, tiles, coated tiles and ceramics, totes, plastic containers, plumbing, electrical and construction supplies, lighting and the like.

The laser marking composition of the present invention can be applied to the substrate in any variety of applications. In one embodiment, the composition is sprayed onto the substrate. Typically, the composition is applied through use of aerosol-type spraying or airbrushing-type spraying. In this way, the application can be generally uniform in coating. In another embodiment, the composition is applied through use of a brush, including but not limited to foam brush application and bristle brush application. In another embodiment, the composition is applied as a paste. In another embodiment, the composition is applied as an aqueous application, including but not limited to screen printing ink application pad printing ink application and the like.

The laser marking composition can also be dispersed in a carrier and applied to a substrate surface by rubbing the surface of the substrate with the carrier/composition combination. In another embodiment, a layer of the composition can be applied in the form of a tape, sticker or decal on the substrate surface. Specifically, in accordance with another embodiment a layer of laser marking composition is applied to an adhesive sheet of backing material, for example, a plastic or paper sheet. The layer of laser marking composition and backing material are applied to the substrate and then is irradiated by a laser, which projects a beam onto the surface of the laser marking composition. The irradiated portion creates a mark or design which adheres to the surface of the substrate forms on a permanent or semi-permanent basis. Then, the non-irradiated portion of the marking material is removed by peeling the backing material from the substrate (where the non-irradiated portion remains adhered to the backing material) such that the irradiated portion remains fixed to the substrate.

In one embodiment, the laser mark is semi-permanent. In some embodiments, semi-permanent means that such laser mark is resistant to both scrubbing and re-oxidation. The compounds used in the present invention can be in the form of particles having a D3.2 average particle size in the range from 10 nm to 10 μm, typically less than 1 μm, and more typically less than 100 nm. The particles can comprise a core-shell arrangement with the inner core being composed of the colored material and the outer shell comprising the hot melt adhesive compound.

Any suitable laser or similar irradiating device can be used in conjunction with the present invention to mark a substrate. In one embodiment, imaging or patterning of a substrate is accomplished through the use of a diode array and CO₂ lasers, namely, ND:YAG and industrial CO₂ (10,600 nm wavelength). Generally, ND:YAG lasers emit light in the near-infrared spectrum (i.e., wavelengths of around 1064 nm). ND:YAG lasers have outputs (continuous) of from about 1 to about 50 watts. ND:YAG lasers in a pulsed mode can operate at typical peak powers of from about 1 watt to about 50 kilowatts, with frequencies of from about 1 to about 64,000 pulses/second. CO₂ lasers have outputs (continuous) of from about 1 to about 40 watts.

The marking component (e.g., color-forming component), in one embodiment, can be any suitable color-forming component. Examples of suitable color-formers include one or more of a range of conventional materials such as electron-donating materials, e.g. phthalides, fluorans and leuco dyes, for example crystal violet lactone. Lewis acids, whether electron-accepting or acid-generating, can also be used; examples are hydroxybenzoate, bisphenol A, zinc stearate and others. In another embodiment, metallo-porphyrins, metallo-thiolenes, metallo-polythiolenes, metallo-phthalocyanines, aza-variants or annellated variants of any of these, pyrylium salts, squaryliums, croconiums, amminiums, diimoniums, cyanines and/or indolenine cyanines can be utilized. Other known color-forming materials can be utilized as would be apparent to those of ordinary skill in the art. The laser marking compositions described herein provide for improved color markings on substrates as compared with the prior art, which was prone to rubbing off, flaking, fading, and/or coming off or loose from the substrate.

Pigments such as fumed silica or zinc stearate may also be used, e.g. in an amount of 10-50% w/w. Other materials that may be used include any one or more of antioxidants, reducing agents, lubricating agents, pigments, sensitizers and defoamers.

Due to the effectiveness of the invention in producing a black image on exposure to fiber, diode or diode array laser wavelengths, e.g. when including a non-stoichiometric compound and an oxymetal anion, this may be further exploited by differentiating between activating sources.

The laser marking compositions described herein can be used to produce an IR-sensitive coating that can be applied by a range of methods such as flood-coating, flexo/gravure etc. The coating composition of the present invention can be applied to a range of substrates such as paper, paperboard, flexible plastic film, corrugate board etc. As described above, the composition in another embodiment can be applied to a self-adhesive label or pressure sensitive adhesive label. Further media that may be used in the invention are UV-curable flexographic inks, UV-curable offset inks, conventional offset inks, melt-extrudable polymer and powder coatings.

In another embodiment, suitable marking components includes dyes and organic and inorganic colored pigments, as well as dyes and organic and inorganic colored pigments known to the person skilled in the art. Particularly suitable organic pigments from the color Index list are, for example, monoazo pigments C.I. Pigment Brown 25, C.I. Pigment Orange 5, 13, 36, 67, C.I. Pigment Red 1, 2, 3, 5, 8, 9, 12, 17, 22, 23, 31, 48:1, 48:2, 48:3, 48:4, 49, 49: 1, 52:1, 52:2, 53, 53:1, 53:3, 57:1, 251, 112, 146, 170, 184, 210 and 245, C.I. Pigment Yellow 1, 3, 73, 65, 97, 151 and 183; diazo pigments C.I. Pigment Orange 16, 34 and 44, C.I. Pigment Red 144, 166, 214 and 242, C.I. Pigment Yellow 12, 13, 14, 16, 17, 81, 106, 113, 126, 127, 155, 174, 176 and 188; anthanthrone pigments C.I. Pigment Red 168, anthraquinone pigments C.I. Pigment Yellow 147 and 177, C.I. Pigment Violet 31; anthrapyrimidine pigments C.I. Pigment Red 122, 202 and 206, C.I. Pigment Violet 19; quinophthalone pigments C.I. Pigment Yellow 138; dioxazine pigments C.I. Pigment Yellow 138; dioxazine pigments C.I. Pigment Violet 23 and 37; flavanthrone pigments C.I. Pigment Blue 60 and 64; isoindoline pigments C.I. Pigment Orange 69, C.I. Pigment Red 260, C.I. Pigment Yellow 139 and 185; isoindolinone pigments C.I. Pigment Orange 61, C.I. Pigment Red 257 and 260, C.I. Pigment Yellow 109, 110, 173 and 185; isoviolanthrone pigments C.I. Pigment Violet 31, metal-complex pigments C.I. Pigment Yellow 117 and 153, C.I. Pigment Green 8; perinone pigments C.I. Pigment Orange 43, C.I. Pigment Red 194; perylene pigments C.I. Pigment Black 31 and 32, C.I. Pigment Red 123, 149, 178, 179, 190 and 224, C.I. Pigment Violet 29; phthalocyanine pigments C.I. Pigment Blue 15, 15:1, 15:2, 15:3, 15:4, 15:6 and 16, C.I. Pigment Green 7 and 36; pyranthrone pigments C.I. Pigment Orange 51, C.I. Pigment Red 216; thioindigo pigments C.I. Pigment Red 88 and 181, C.I. Pigment Violet 38; triarylcarbonium pigments C.I. Pigment Blue 1, 61 and 62, C.I. Pigment Green 1, C.I. Pigment Red 81, 81:1 and 169, C.I. Pigment Violet 1, 2, 3 and 27; Aniline Black (C.I. Pigment Black 1); Aldazine Yellow (C.I. Pigment Yellow 101) and C.I. Pigment Brown 22 and liquid crystal polymers (LCP pigments).

It is understood that the above listing of pigments and dyes is not limiting, and other suitable marking component can be utilized. The pigments and dyes described herein can be used individually or combined into a mixture.

Suitable hot melt adhesives/polymer alloys useful in the present invention include but are not limited to polymers containing at least one monomer functional group selected from the following: vinylidene fluoride, hexafluoropropylene, ch lorotrifluoroethylene, tetrafluoroethylene, glycidyl acrylate, glycidyl methacrylate, an ethylenically unsaturated monomer, acrylic acid, acrylic acid esters, methacrylic acid, methacrylic acid esters, styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, or C4-C8 conjugated dienes, 1,3-butadiene, isoprene and chloroprene, trimethylammoniopropyl methacrylate chloride, trimethylammonioethylacrylamide, -methacrylamide chloride, -methacrylamide bromide, trimethylammoniobutylacrylamide, -methylacrylamide methyl sulphate, trimethylammoniopropylmethacrylamide methyl sulphate, (3-methacrylamidopropyl)trimethylammonium chloride, (3-acrylamidopropyl)trimethylammonium chloride, methacryloyloxyethyltrimethylammonium chloride, methacryloyloxyethyltrimethylammonium chloride methyl sulphate, acryloyloxyethyltrimethylammonium salts, 1-ethyl-2-vinylpyridinium, 1-ethyl-4-vinylpyridinium bromide, 1-ethyl-2-vinylpyridinium, 1-ethyl-4-vinylpyridinium chloride, 1-ethyl-2-vinylpyridinium, 1-ethyl-4-vinylpyridinium methyl sulphate, N,N-dimethyldiallylammonium chloride, dimethylaminopropylmethacrylamide, and N-(3-chloro-2-hydroxypropyl)trimethylammonium chloride. In one embodiment, the hot melt adhesives suitable for the present invention are chosen from vinylidene fluoride, hexafluoropropylene, ch lorotrifluoroethylene, tetrafluoroethylene, glycidyl acrylate, glycidyl methacrylate or any combination thereof.

It is also understood that other additives can be included in the composition of the present invention. Other additives that may be utilized include but are not limited to antioxidants, reducing agents, binders, lubricating agents, absorbing agents, surfactants, pigments, sensitizers and defoamers, inert materials such as alumina, titanium oxide, zinc oxide, kaolin or mica.

In one embodiment, the hot melt adhesive comprises a copolymer (hereinafter described as “copolymer” or “polymer”) comprising two or more monomeric units. In another embodiment, the hot melt adhesive comprises a polymer comprising three or more monomeric units.

In one embodiment, the copolymer can comprise monomeric units derived from the following monomeric groups: (i) at least one ethylenically unsaturated monomer having a fluoride group, and (ii) at least one ethylenically unsaturated monomer having a glycidyl group. The polymer, upon irradiation at a range of between about 780 nm and 11000 nm, enables the laser marking composition to be attached on a semi-permanent basis to a substrate.

In one embodiment, the at least one monomeric unit having a fluoride group (wherein the monomeric unit is derived from at least one ethylenically unsaturated monomer having a fluoride group) is present in the polymer in an amount from about 50% to 90% by weight, based on the total weight of the monomeric units. In another embodiment, the at least one monomeric unit having a fluoride group is present in the polymer in an amount from about 65% to 80% by weight, based on the total weight of the monomeric units. In a further embodiment, the at least one monomeric unit having a fluoride group is present in the polymer in an amount from about 70% to 80% by weight, based on the total weight of the monomeric units. It is understood that in the case where the at least one monomeric above comprises two or more monomeric units having a fluoride group, the amounts listed is the combined or total weight of the two or more monomeric units having a fluoride group.

In one embodiment, the monomeric unit having a glycidyl group (wherein the monomeric unit is derived from at least one ethylenically unsaturated monomer having a glycidyl group) is present in the polymer in an amount from about 20% to 50% by weight, based on the total weight of the monomeric units. In another embodiment, the monomeric unit having a glycidyl group is present in the polymer in an amount from about 20% to 40% by weight, based on the total weight of the monomeric units. Typically, the monomeric unit having a glycidyl group is present in the polymer in an amount from about 25% to 35% by weight, based on the total weight of the monomeric units. In yet another embodiment, the monomeric unit having a glycidyl group is present in the polymer in an amount from about 30% to 35% by weight, based on the total weight of the monomeric units.

In a further embodiment, the polymer of the hot melt adhesive further comprises a monomeric unit derived from an ethylenically unsaturated monomer having a non-ionic group. In one embodiment, the non-ionic group is chosen from

The copolymers according to the invention can be obtained by any suitable method, for example by free-radicals polymerization, controlled or not, or by ring-opening polymerization (including anionic or cationic polymerization), or by anionic or cationic polymerization, or by chemical modification of a polymer. Free-radicals polymerizations, referred to as “controlled” are typical. There are several methods for making block copolymers.

In one embodiment, the composition or formulation of the present invention is water or solvent-free or substantially water or solvent-free. The composition of the present invention can be in dry or semi-dry form, generally in the form of a powder, meaning the composition contains less than 15% by weight water or solvent, typically less than 10% be weight water or solvent, or more typically less than about 5% by weight water or solvent (in the semi-dry form). In some embodiments, the composition is a viscous or semi-viscous paste.

In another embodiment, the composition or formulation of the present invention can be combined with carrier fluid, liquid or solvent. The solvent can be aqueous or organic. For example, the carrier fluid can comprise water or an organic solvent such as a diol, ethanol, isopropanol, methyl ethyl ketone, or ethyl acetate. In one embodiment, the carrier fluid is optionally mixed with an amine and/or surfactant, e.g. water, ethanol, ethyl acetate, isopropyl alcohol, hydrocarbons, etc.

In another embodiment, the present invention is a method of laser-marking a substrate comprising a) obtaining a laser marking composition comprising a marking composition and a hot melt adhesive; b) contacting the composition with a substrate; and c) irradiating the composition with a laser having a wavelength of between about 700 nm and 11000 nm, thereby causing the composition to form a semi-permanent bond with the substrate. In another embodiment, the laser marking composition further comprises additional components, including but not limited to solvents and carriers.

In yet another embodiment, the present invention is a method of marking a substrate comprising: a) obtaining a laser marking composition comprising a marking composition and a hot melt adhesive; c) determining a desired pattern to be formed on the substrate; b) contacting the composition with a substrate; and c) irradiating the composition in the desired pattern with a laser. Typically, the laser is in the IR or Near-IR range, having a wavelength of between about 700 nm and 11000 nm. This causes the composition to form a semi-permanent bond with the substrate in the form of the pattern. In one embodiment, the laser marking composition further comprises additional compounds/additives.

### EXAMPLES

### Laser Marking Experiments

### Example 1

### Acrylic Plastic Sheets Laser Marking

Formulation 1, hot melt adhesive polymer (copolymer comprising monomeric units derived from the following monomeric groups: (i) at least one ethylenically unsaturated monomer having a fluoride group, and (ii) at least one ethylenically unsaturated monomer having a glycidyl group, and (iii) butyl acrylate) are mixed in a pan with a pigment. The mixture was blended in a high intensity mixer until a homogeneous blend was obtained, then melt-compounded on a two roll mill operating at a temperature of about 200° C. and granulated into pellets. The pellets were soaked in liquid nitrogen and cryogenically ground in a hammer mill equipped with a 0.010 inch slotted screen. Liquid nitrogen was fed into the hammer mill during the grinding operation. The resultant powder was then classified using sieves and the powder which passed through 325 mesh screen was collected as useful material.

This resulting powder was mixed with ethyl alcohol, denatured) and sprayed on to the substrate in a thin layer (less than about 10 micron thick). The substrate having the thin layer is an acrylic sheet (from Plexiglass) and was air dried for about two minutes and then laser marked with a 25 W CO₂ laser from Universal lasers, USA (90% power, 70% speed, 1000 pixels per inch (“PPI”) resolution density). It was observed that the black markings were sharp and permanent with good abrasion resistance. (Taber test for abrasion resistance.)

### Example 2

### Wood and Rubber Laser Marking

Formulation 2, hot melt adhesive polymer [copolymer comprising monomeric units derived from the following monomeric groups: (i) at least one ethylenically unsaturated monomer having a fluoride group, and (ii) at least one ethylenically unsaturated monomer having a glycidyl group, and (iii) polyvinyl acetate] is mixed in a pan with a black pigment (Shepherd Black 430). The mixture was blended in a high intensity mixer until a homogeneous blend was obtained, then melt-compounded on a two roll mill operating at a temperature of about 200° C. and granulated into pellets. The pellets were soaked in liquid nitrogen and cryogenically ground in a hammer mill equipped with a 0.010 inch slotted screen. Liquid nitrogen was fed into the hammer mill during the grinding operation. The resultant powder was then classified using sieves and the powder which passed through 325 mesh screen was collected as useful material.

This resulting powder was mixed with ethyl alcohol, denatured) and sprayed on to the substrate in a thin layer (less than about 10 micron thick). The wood and rubber substrates were marked with the same laser (substrate air dried and then laser marked with a 25 W CO₂ laser from Universal lasers), except, with a setting of - - - 10% power, 70% speed and 700 PPI (pixels per inch) resolution density. It was observed that the black marks had good adherence on wood and rubber (including tires).

### Example 3

### Leather Laser Marking

Formulation 3, hot melt adhesive polymer [copolymer comprising monomeric units derived from the following monomeric groups: (i) at least one ethylenically unsaturated monomer having a fluoride group, and (ii) at least one ethylenically unsaturated monomer having a glycidyl group, and (iii) vinyl butyrate] is mixed with a black pigment (Shepherd Black 430). The mixture was blended in a high intensity mixer until a homogeneous blend was obtained, then melt-compounded on a two roll mill operating at a temperature of about 200° C. and granulated into pellets. The pellets were soaked in liquid nitrogen and cryogenically ground in a hammer mill equipped with a 0.010 inch slotted screen. Liquid nitrogen was fed into the hammer mill during the grinding operation. The resultant powder was then classified using sieves and the powder which passed through 325 mesh screen was collected as useful material.

This resulting powder was mixed with ethyl alcohol, denatured) and sprayed on to the substrate in a thin layer (less than about 10 micron thick). They were laser marked on different leather sheets at laser settings of 15% power and 80% speed. Good adhering black laser marks on leather were observed.

It is apparent that embodiments other than those expressly described herein come within the spirit and scope of the present claims. Accordingly, the present invention is not defined by the above description, but is to be accorded the full scope of the claims so as to embrace any and all equivalent compositions and methods.

What is claimed is:

1. A laser marking composition comprising (i) a marking component and (ii) a hot melt adhesive, the hot melt adhesive comprising a polymer having at least one monomeric unit having a fluoride group, and at least one monomeric unit having a glycidyl group, wherein upon irradiation in a wavelength range of between about 700 nm and 14000 nm the laser marking composition bonds to a substrate to which it is contacted.

2. The composition of claim 1 further comprising a binder.

3. The composition of claim 1 wherein the hot melt adhesive is a polymer comprising two or more monomeric units, wherein the two or more monomeric units are individually derived from: vinylidene fluoride, hexafluoropropylene, chiorotrifluoroethylene, tetrafluoroethylene, glycidyl acrylate, glycidyl methacrylate, an ethylenically unsaturated monomer, acrylic acid, polyvinyl acetate, acrylic acid esters, methacrylic acid, methacrylic acid esters, styrene, alpha-methyl styrene, vinyl chloride, acrylonitrile, methacrylonitrile, ureido methacrylate, vinyl acetate, vinyl esters of branched tertiary monocarboxylic acids, butyl acrylate, itaconic acid, crotonic acid, maleic acid, fumaric acid, ethylene, or C4-C8 conjugated dienes, 1,3-butadiene, isoprene and chloroprene, trimethylammoniopropyl methacrylate chloride, trimethylammonioethylacrylamide, -methacrylamide chloride, -methacrylamide bromide, trimethylammoniobutylacrylamide, -methylacrylamide methyl sulphate, trimethylammoniopropylmethacrylamide methyl sulphate, (3-methacrylamidopropyl)trimethylammonium chloride, (3-acrylamidopropyl)trimethylammonium chloride, methacryloyloxyethyltrimethylammonium chloride, methacryloyloxyethyltrimethylammonium chloride methyl sulphate, acryloyloxyethyltrimethylammonium salts, 1-ethyl-2-vinylpyridinium, 1-ethyl-4-vinylpyridinium bromide, 1-ethyl-2-vinylpyridinium, 1-ethyl-4-vinylpyridinium chloride, 1-ethyl-2-vinylpyridinium, 1-ethyl-4-vinylpyridinium methyl sulphate, N,N-dimethyldiallylammonium chloride, dimethylaminopropylmethacrylamide, or N-(3-chloro-2-hydroxypropyl)trimethylammonium chloride.

4. The composition of claim 1 wherein the hot melt adhesive is a polymer comprising at least 3 monomeric units, wherein each monomeric unit is derived from a monomer selected from: vinylidene fluoride, hexafluoropropylene, chlorotrifluoroethylene, tetrafluoroethylene, glycidyl acrylate, glycidyl methacrylate, polyvinyl acetate, vinyl acetate or butyl acrylate.

5. The composition of claim 1 wherein the marking component is colored.

6. The composition of claim 1 wherein irradiation is performed a range of between about 700 nm and 11000 nm.

7. The composition of claim 1 wherein the marking component is selected from the group consisting of monoazo pigments, C.I. Pigment Brown, C.I. Pigment Orange, C.I. Pigment Red, C.I. Pigment yellow; diazo pigments, C.I. Pigment Orange, anthanthrone pigments, anthraquinone pigments, C.I. Pigment Violet, anthrapyrimidine pigments, quinophthalone pigments, dioxazine pigments, flavanthrone pigments, C.I. Pigment Blue, isoindoline pigments, isoviolanthrone pigments, metal-complex pigments, C.I. Pigment Green; perinone pigments, perylene pigments, C.I. Pigment Black, phthalocyanine pigments, pyranthrone pigments, thioindigo pigments, triarylcarbonium pigments, Aniline Black, Aldazine Yellow, C.I. Pigment Brown and liquid crystal polymer pigments (LCP pigments).

8. The formulation of claim 1 wherein the substrate comprises metal, ceramic, glass, porcelain, marble, natural stone, plastic, paper, rubber, wood, cardboard or a combination thereof.

9. The formulation of claim 1 wherein the substrate is selected from the group consisting of glass, lead-free glass, ceramic tiles, sanitary ware, stoneware, porcelain, bricks, electronic quality ceramic substrates, marble, granite, slate, limestone, metal, steel, brass, copper, aluminum, tin, zinc, PVC, polyamides, polyolefins, polyethylenes, polycarbonates and polytetrafluoroethylene.

10. A method of laser marking a substrate in a desired pattern comprising:
a) obtaining a laser marking composition comprising a marking composition and a hot melt adhesive;
b) contacting the composition with a substrate; and
c) irradiating the composition with a laser having a wavelength of between about 700 nm and 11000 nm, thereby causing the composition to form a bond with the substrate.

11. The method of claim 10 wherein the hot melt adhesive comprises a polymer having at least one monomeric unit having a fluoride group, and at least one monomeric unit having a glycidyl group.

12. The method of claim 10 wherein the hot melt adhesive comprises a polymer which, based on the total weight of monomers, comprises the following:
(a) from about 65 to about 80 percent by weight fluoride monomeric units, each fluoride monomeric unit independently comprising at least one fluoride substituent group, (b) from about 20 to about 35 percent by weight glycidyl monomeric units, each glycidyl monomeric unit independently comprising at least one glycidyl group, and (c) from about 0.5 to about 2.0 percent by weight nonionic monomeric units, each nonionic monomeric unit independently comprising a nonionic substituent group.

13. The method of claim 10 wherein the hot melt adhesive is a polymer comprising two or more monomeric units, wherein the two or more monomeric units are individually derived from: vinylidene fluoride, hexafluoropropylene, chlorotrifluoroethylene, tetrafluoroethylene, glycidyl acrylate, glycidyl methacrylate, an ethylenically unsaturated monomer, acrylic acid, polyvinyl acetate, acrylic acid esters, methacrylic acid, methacrylic acid esters, styrene, alpha-methyl styrene, vinyl chloride, acrylonitrile, methacrylonitrile, ureido methacrylate, vinyl acetate, vinyl esters of branched tertiary monocarboxylic acids, butyl acrylate, itaconic acid, crotonic acid, maleic acid, fumaric acid, ethylene, or C4-C8 conjugated dienes, 1,3-butadiene, isoprene and chloroprene, trimethylammoniopropyl methacrylate chloride, trimethylammonioethylacrylamide, -methacrylamide chloride, -methacrylamide bromide, trimethylammoniobutylacrylamide, -methylacrylamide methyl sulphate, trimethylammoniopropylmethacrylamide methyl sulphate, (3-methacrylamidopropyl)trimethylammonium chloride, (3-acrylamidopropyl)trimethylammonium chloride, methacryloyloxyethyltrimethylammonium chloride, methacryloyloxyethyltrimethylammonium chloride methyl sulphate, acryloyloxyethyltrimethylammonium salts, 1-ethyl-2-vinylpyridinium, 1-ethyl-4-vinylpyridinium bromide, 1-ethyl-2-vinylpyridinium, 1-ethyl-4-vinylpyridinium chloride, 1-ethyl-2-vinylpyridinium, 1-ethyl-4-vinylpyridinium methyl sulphate, N,N-dimethyldiallylammonium chloride, dimethylaminopropylmethacrylamide, or N-(3-chloro-2-hydroxypropyl)trimethylammonium chloride.

14. The method of claim 10 wherein the marking component is a colorant.

15. The method of claim 10 wherein the hot melt adhesive is a polymer comprising at least 3 monomeric units, wherein each monomeric unit is derived from a monomer selected from: vinylidene fluoride, hexafluoropropylene, chlorotrifluoroethylene, tetrafluoroethylene, glycidyl acrylate, glycidyl methacrylate, polyvinyl acetate, vinyl acetate or butyl acrylate.

16. The method of claim 10 further comprising the step of determining a desired pattern to be formed on the substrate.

17. The method of claim 10 wherein the step of contacting the composition with a substrate comprises electrostatially applying a layer of the composition onto the substrate.

18. The method of claim 10 wherein the step of contacting the composition with a substrate comprises spraying a layer of the composition onto the substrate.

19. The method of claim 10 wherein the pattern is selected from the group consisting of a pattern, a bar code, an identifying code and a name.

20. The method of to claim 10, wherein the laser is selected from a CO₂ laser.
